(19) United States
(12) Patent Application Publication
(10) Pub. No.: US 2010/0256927 A1
(43) Pub. Date: Oct. 7, 2010

(54) Methods of Detecting Valve Closure in Reciprocating Compressors

(75) Inventors: Roger A. Hala, Gardnerville, NV (US); Brian F. Howard, Issaquah, WA (US); Ivan Joseph Johnson, Watertown, MA (US); Charles Terrance Hatch, Gardnerville, NV (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 12/419,021

(22) Filed: Apr. 6, 2009

(51) Int. Cl. G06F 19/00

(52) U.S. Cl. 702/33

(57) ABSTRACT

A method estimates closure of a suction valve. A number of samples are received, each including a reference and a pressure reading. Data points are determined from the samples, each including a reference and a pressure indicator. The reference indicator directly correlates to the reference reading, and the pressure indicator correlates to an average of pressure readings collected about the sample. The data points include a suction data point, a discharge data point, and an index data point. A best-fit linear equation representing data points from about the index data point to about the discharge data point is determined. A half-slope linear equation is also determined, which has half the slope of the best-fit linear equation and the index data point as one solution. A best-fit polynomial equation representing data points from about the suction data point to about the index data point is determined, and a target reference indicator associated with a maximum directed distance from the best-fit polynomial equation to the half-slope linear equation is identified. The suction valve is estimated to close at a point identified by the target reference indicator.

### TECHNICAL FIELD

The present disclosure generally relates to systems and methods of detecting valve closure in a compressor, and more particularly relates to systems and methods of detecting suction valve closure in a reciprocating compressor.

### BACKGROUND OF THE INVENTION

Reciprocating compressors include certain valves that open and close throughout the cycle. For example, a suction valve opens and closes to permit or prevent the entry of gas into the compressor, while a discharge valve opens and closes to permit or prevent the exit of gas from the compressor. Traditionally, reciprocating compressors have been designed to close the valves at certain standard crankshaft rotation angles, such as top dead center or bottom dead center. More recently, stepless unloader devices have been implemented on reciprocating compressors to permit dynamically controlling compressor capacity. The stepless unloader mechanically holds the suction valve open for a portion of the compression cycle to reduce the volume of gas in the compression chamber. Thus, the stepless unloader closes the suction valve at varying crankshaft rotation angles depending on the desired compressor output.

Existing compressors often have no means of determining when the suction valve actually closes, which may be undesirable. For example, many performance and diagnostic calculations for the compressor may require knowledge of the actual suction valve closure point. For traditional compressors, these performance and diagnostic calculations may be completed by assuming that the suction valve closes as anticipated at either top dead center or bottom. One problem with this approach is that the calculations may be distorted if the assumption is invalid. Further, a malfunction in the valve may go undetected.

For newer reciprocating compressors with stepless unloaders, the performance and diagnostic calculations may be addressed by temporarily disabling the stepless unloader and running the compressor at full capacity, so that the valves can be assumed to close at top or bottom dead center. However, disabling the stepless unloader disrupts the industrial process and may be impractical. Even if the stepless unloader can be disabled, the resulting performance calculations are not indicative of normal operation with the stepless unloader enabled. This approach also presents the problems described above with reference to a traditional compressor, in that the calculations may be distorted if the valves do not close as anticipated and a malfunctioning valve may not be detected.

Therefore, a need exists for systems and methods of detecting valve closure in reciprocating compressors.

### BRIEF DESCRIPTION OF THE INVENTION

A method estimates closure of a suction valve in a reciprocating compressor. A number of samples associated with an operating cycle of the reciprocating compressor are received. Each sample includes a reference reading and a pressure reading. A number of data points are determined. Each data point corresponds to one of the samples. Each data point includes a reference indicator and a pressure indicator. The reference indicator directly correlates to the reference reading of the sample. The pressure indicator correlates to an average of pressure readings collected about the sample. The data points include a suction data point that estimates a beginning of a piston stroke, a discharge data point that estimates an ending of a piston stroke, and an index data point corresponding to an interim point on the piston stroke. A best-fit linear equation representing data points from about the index data point to about the discharge data point is determined. A half-slope linear equation is also determined. The half-slope linear equation has a slope that is about one-half of a slope of the best-fit linear equation. The index data point is one solution to the half-slope linear equation. A best-fit polynomial equation representing data points from about the suction data point to about the index data point is determined. A target reference indicator is identified. The target reference indicator is associated with a maximum directed distance from the best-fit polynomial equation to the half-slope linear equation. The suction valve is estimated to close at a point in the cycle identified by the target reference indicator.

Other systems, devices, methods, features, and advantages of the disclosed systems and methods will be apparent or will become apparent to one with skill in the art upon examination of the following figures and detailed description. All such additional systems, devices, methods, features, and advantages are intended to be included within the description and are intended to be protected by the accompanying claims.

### BRIEF DESCRIPTION OF THE DRAWINGS

The present disclosure may be better understood with reference to the following figures. Matching reference numerals designate corresponding parts throughout the figures, and components in the figures are not necessarily to scale.

FIGS. 1a through 1e are schematic cross-sectional views of an embodiment of a compressor chamber, illustrating the compressor at various stages of an operational cycle.

FIG. 2 is a graph illustrating pressure as a function of crankshaft rotation angle for the operational cycle of the compressor shown in FIG. 1.

FIG. 3 is a graph illustrating pressure as a function of volume for the operational cycle of the compressor shown in FIG. 1.

FIG. 4 is a block diagram illustrating an embodiment of a method of detecting closure of a valve in a reciprocating compressor.

FIGS. 5a and 5b are plots of data points collected from a compressor, each data point representing pressure as a function of volume, the graphs further demonstrating the method of FIG. 4.

FIG. 6 is a graph illustrating pressure as a function of volume for an operational cycle of a compressor, with the graph adjusted according to a logarithmic scale.

FIG. 7 is graph comparing raw data points collected from a compressor with a best-fit polynomial equation computed using double-precision floating point arithmetic and a best-fit polynomial equation computed in a modified coordinate system.

FIG. 8 is a block diagram illustrating another embodiment of a method of detecting closure of a valve in a reciprocating compressor.

FIG. 9 is a block diagram illustrating an embodiment of a system for detecting closure of a valve in a reciprocating compressor.

### DETAILED DESCRIPTION OF THE INVENTION

Described below are embodiments of systems and methods of detecting valve closure in a reciprocating compressor. The systems and methods may detect the closure of a suction valve, a discharge valve, or both. More particularly, the systems and methods may determine the closure of the valve as a function of crankshaft rotation angle, compressor volume, time, or piston position, among others.

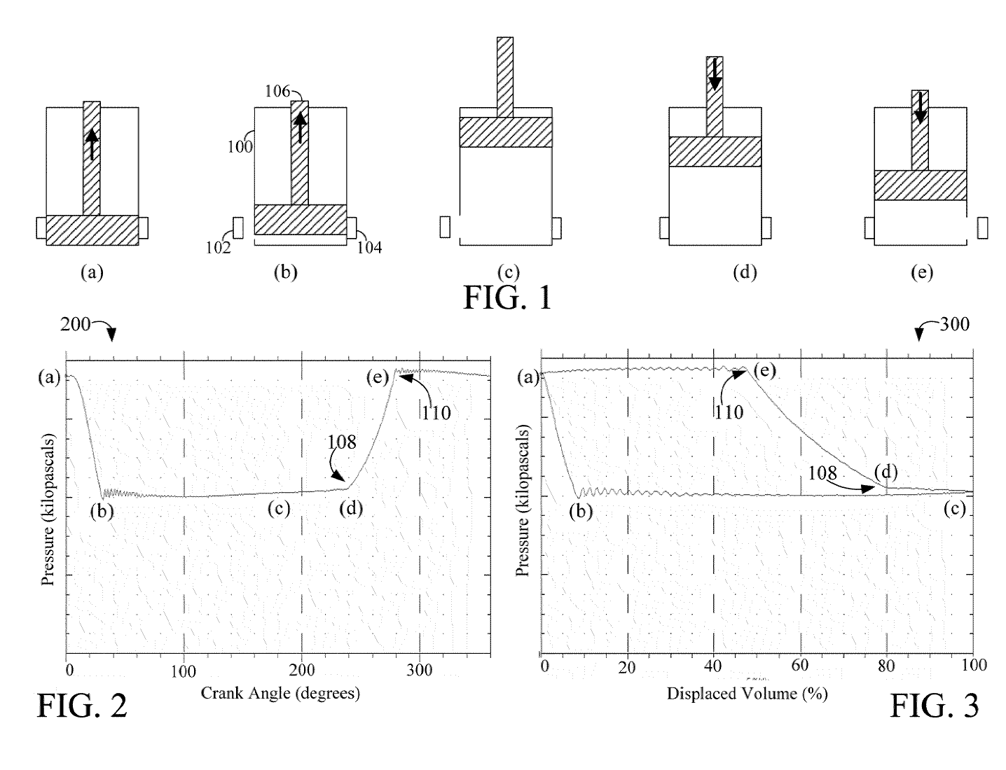

FIG. 1 is a cross-sectional view of an embodiment of a reciprocating compressor 100, illustrating the operation of a suction valve 102 and a discharge valve 104 of the compressor for various positions of a piston 106. FIG. 2 is a graph 200 illustrating pressure as a function of crankshaft rotation angle for the compressor 100, and FIG. 3 is a graph 300 illustrating pressure as a function of compressor volume for the same compressor 100. The points marked (a) through (e) on FIGS. 2 and 3 correlate to the various stages of the compressor cycle shown in FIG. 1 and described below.

Specifically, FIG. 1a illustrates an expansion cycle, during which the suction valve 102 and the discharge valve 104 are closed. The piston 106 moves away from top dead center toward bottom dead center, the compressor volume increases, and the gas in the compressor expands. FIG. 1b illustrates a suction cycle, during which the suction valve 102 is opened. The piston 106 continues moving toward bottom dead center, drawing gas into the compressor 100 through the opened suction valve 102. At FIG. 1c, the piston 106 reaches bottom dead center and reverses in direction. In a compressor equipped with a stepless unloader such as the illustrated compressor 100, the suction valve 102 is held open as the crankshaft rotates past bottom dead center, permitting some gas to escape back into the suction manifold. Thereby, the output of the compressor 100 may be dynamically controlled. Subsequently, the suction valve 102 is closed as shown in FIG. 1d, and the compression cycle begins. The piston 106 continues traveling toward top dead center, compressing the gas. FIG. 1e illustrates a discharge cycle, during which the discharge valve 104 is opened. The piston 106 continues traveling toward top dead center, discharging the compressed gas through the opened discharge valve 104. Once the piston 106 returns to top dead center, the discharge valve 104 closes, and the cycle begins again as described above with reference to FIG. 1a.

As shown in FIGS. 2 and 3, a knee 108 occurs in the pressure curves 200, 300 when the suction valve 102 closes. The knee 108 represents the transition from the suction cycle to the compression cycle. During the suction cycle, the pressure within the compressor 100 stays relatively constant, as demonstrated by the shapes of the curves 200, 300 before the knee 108. When the suction valve 102 closes, the pressure in the compressor 100 begins increasing, as demonstrated by the shapes of the curves 200, 300 about the knee 108. During the compression cycle, the pressure within the compressor 100 increases at a roughly linearly rate, as demonstrated by the shapes of the curves 200, 300 after the knee 108.

Similarly, another knee 110 occurs in the pressure curves when the discharge valve 104 opens. The knee 110 represents the transition from the compression cycle to the discharge cycle. When the discharge valve 104 opens, the pressure in the compressor 100 stops increasing, as demonstrated by the shapes of the curves 200, 300 about the knee 118. During the discharge cycle, the pressure within the compressor 100 remains relatively constant, as demonstrated by the shapes of the curves 200, 300 after the knee 110.

The systems and methods described below permit detecting valve closure in the compressor by identifying an abrupt slope change, or “knee”, in the compressor pressure profile. This disclosure generally describes systems and methods of detecting suction valve closure in a reciprocating compressor equipped with a stepless unloader by identifying the ending of the suction cycle and the beginning of the compression cycle. In other words, the disclosure generally describes identifying the knee 108 in one of the pressure curves 200, 300 of FIGS. 2 and 3. However, a person of skill in the art will appreciate that the disclosed systems and methods have broader applicability. For example, the systems and methods may detect the closure of a suction valve, a discharge valve, or both. Closure of the discharge valve may be detected by identifying the location of the knee 110 in one of the pressure curves 200, 300.

Further, the systems and methods may detect the closure of a valve in a compressor that is or is not equipped with a stepless unloader or other capacity control device. Because the illustrated compressor 100 is equipped with a stepless unloader, the suction valve 102 closes after the piston 106 has reversed direction and the compressor volume has decreased, as shown in FIG. 1d. Thus, the knee 108 indicating the ending on the suction cycle and the beginning of the compression cycle occurs after the piston passes bottom dead center in FIG. 1c. In a traditional compressor that is not equipped with a stepless unloader, the suction valve 102 closes about when the piston 106 passes bottom dead center, as shown in FIG. 1c. Thus, the pressure curve for a traditional compressor may look different from the curves 200, 300, but the presence of an abrupt increase in pressure still exists.

The systems and methods may identify closure of the valve as a function of crankshaft rotation angle, compressor volume, time, a proxy for one of these parameters, or a combination thereof. For example, the curve 200 in FIG. 2 illustrates pressure as a function of crankshaft rotation angle, while the curve 300 in FIG. 3 illustrates pressure as a function of compressor volume, and yet both curves include the knee 108 that indicates closure of the suction valve 102. The crankshaft rotation angle is essentially a proxy for time, as the crankshaft is normally rotated at a relatively constant angular velocity. Thus, a pressure curve illustrating pressure as a function of time would be similar in shape to the curve 200 and would include a knee 108 indicating closure of the suction valve 102. Also, both crankshaft rotation angle and time are essentially proxies for the location of the piston within the compressor chamber, and thus a curve illustrating pressure as a function of piston position would be similar in shape to the curve 200 and would include the knee 108 indicating closure of the suction valve 102. These or other parameters may be used to identify valve closure depending on how pressure data is collected from the compressor.

For the purposes of this disclosure, the term top dead center refers to a crankshaft rotation angle of 0°, and the term bottom dead center refers to a crankshaft rotation angle of 180°, although other configurations are possible. In the exemplary case of the illustrated compressor 100, the suction valve closes at some crankshaft rotation angle between bottom dead center and top dead center. The compressor volume is at a relative minimum when the crankshaft achieves top dead center, and the compressor volume is at a relative maximum when the crankshaft achieves bottom dead center. These relationships to crankshaft rotation angle result because the illustrated compressor 100 features a head-end cylinder, meaning the valves are located at an opposite end of the compressor from the driving rod of the piston 106. However, the systems and methods may be employed with reference to a compressor having a head-end cylinder, a crank-end cylinder, or both. In a compressor featuring a crank-end cylinder, the valves are located at an opposite end of the compressor chamber, meaning an end closest to the driving rod of the piston 106. Thus, the compressor volume is at a relative minimum when the crankshaft achieves bottom dead center and the compressor volume is at a relative maximum when the crankshaft achieves top dead center. In such a compressor having a stepless unloader, the suction valve closes at some point after the crankshaft rotates past top dead center, meaning between a crankshaft rotation angle of 0° and 180°. Thus, a curve indicating pressure as a function of crankshaft rotation angle would be 1800 out of phase from the pressure curve 200 but would still include a knee 108 indicating the closure of the suction valve. Likewise, a curve indicating pressure as a function of displaced volume would be the mirror image of the pressure curve 300, but would still include a knee 108 indicating the closure of the suction valve 102.

By identifying the location of the knee in a pressure curve, the systems and methods permit estimating closure of a valve according to one embodiment/aspect of the invention. The systems and methods may estimate the closure of a valve, such as a suction valve or discharge valve. The valve closure may be estimated as a function of another compressor parameter, such as crankshaft rotation angle, volume, time, or piston position. The valve closure may be estimated for a compressor having either a head-end or crank-end chamber. The valve closure may be estimated for a compressor that may or may not have a stepless unloader.

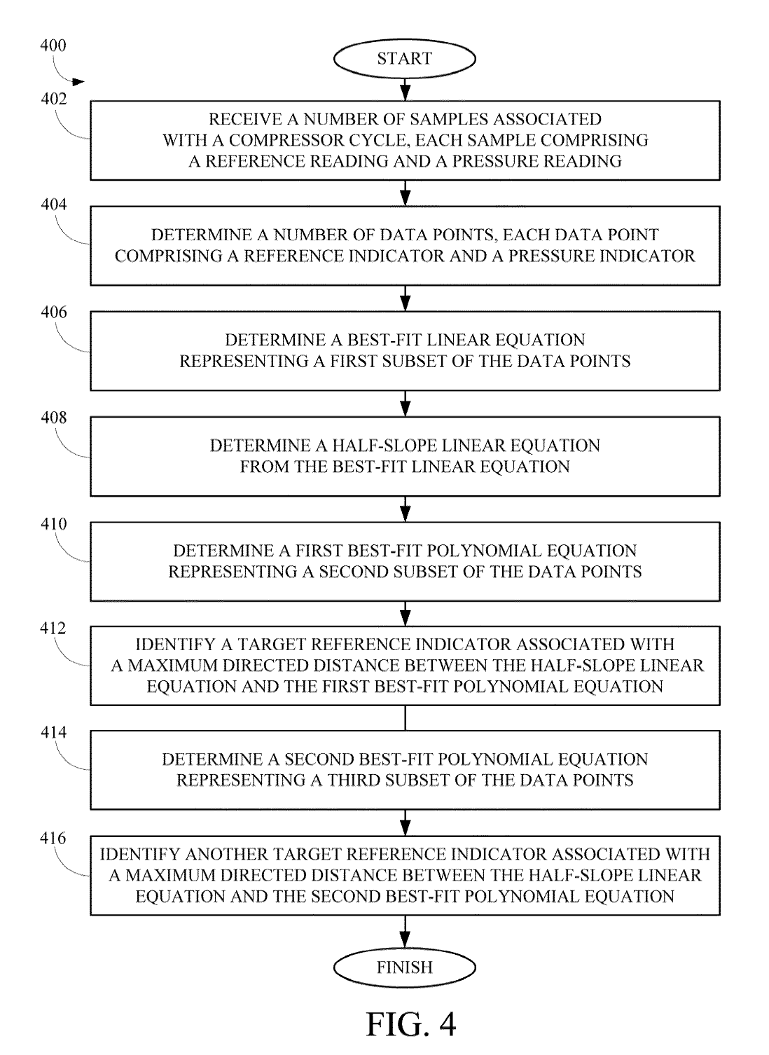

FIG. 4 is block diagram illustrating an embodiment of a method 400 of detecting closure of a valve in a reciprocating compressor. The method generally describes identifying a suction valve closure event for a compressor having a crank-end cylinder and a stepless unloader, although the method has broader applicability as described above. In block 402, a number of samples associated with at least a portion of the compressor cycle are collected. The samples may be collected from the compressor at evenly spaced intervals during the cycle. For example, three-hundred sixty samples may be collected, one sample being taken for each 0.5° of crankshaft rotation. These samples may be collected as the crankshaft rotates and moves the piston from top dead center to bottom dead center. Because a stepless unloader closes the suction valve on a crank-end chamber between these two points, the suction valve closure event may be embedded in the collected samples. A larger or smaller number of samples may be collected, which affects the accuracy and resolution of the method accordingly. The samples may also be collected over other ranges of crankshaft rotation. For example, seven hundred twenty samples may be collected, one for each 0.5° of crankshaft rotation, as the crankshaft completes a full rotation from top dead center back to top dead center. The samples may also be collected over other ranges of crankshaft rotation depending on whether the event being detected is the suction valve closure or the discharge valve closure, and also depending on whether the compressor includes a head-end cylinder or a crank-end cylinder. For example, samples may be collected during the suction cycle and the compression cycle to detect closure of the suction valve, while samples may be collected during the discharge cycle and the expansion cycle to detect closure of the discharge valve. In a head-end chamber, the suction and compression cycles may occur as the crankshaft rotates between top dead center and bottom dead center, and the discharge and expansion cycles may occur as the crankshaft rotates from bottom dead center back to top dead center. In a crank-end cylinder, the discharge and expansion cycles may occur at the crankshaft rotates between bottom dead center and top dead center, and the suction and compression cycles may occur as the crankshaft rotates from top dead center back to bottom dead center. Regardless, a sharp increase in slope, or knee in a pressure curve, may be embedded in the collected samples.

Each sample may include a reference reading and a pressure reading. The reference and pressure readings may correspond to each other, with the reference reading identifying a point in the compressor cycle at which the pressure reading was taken. The reference reading may be one or more of the following: crankshaft rotation angle, cylinder volume, time, piston position, a proxy for one of these parameters, or a combination thereof.

In block 404, the samples may be processed to create a number of data points. One data point may be created for each sample. Each data point may include a reference indicator and a pressure indicator. Collectively, the data points may be used to approximate a pressure curve for the cycle. The approximated pressure curve may be analyzed to identify a sharp slope increase, which may indicate the suction valve closure event.

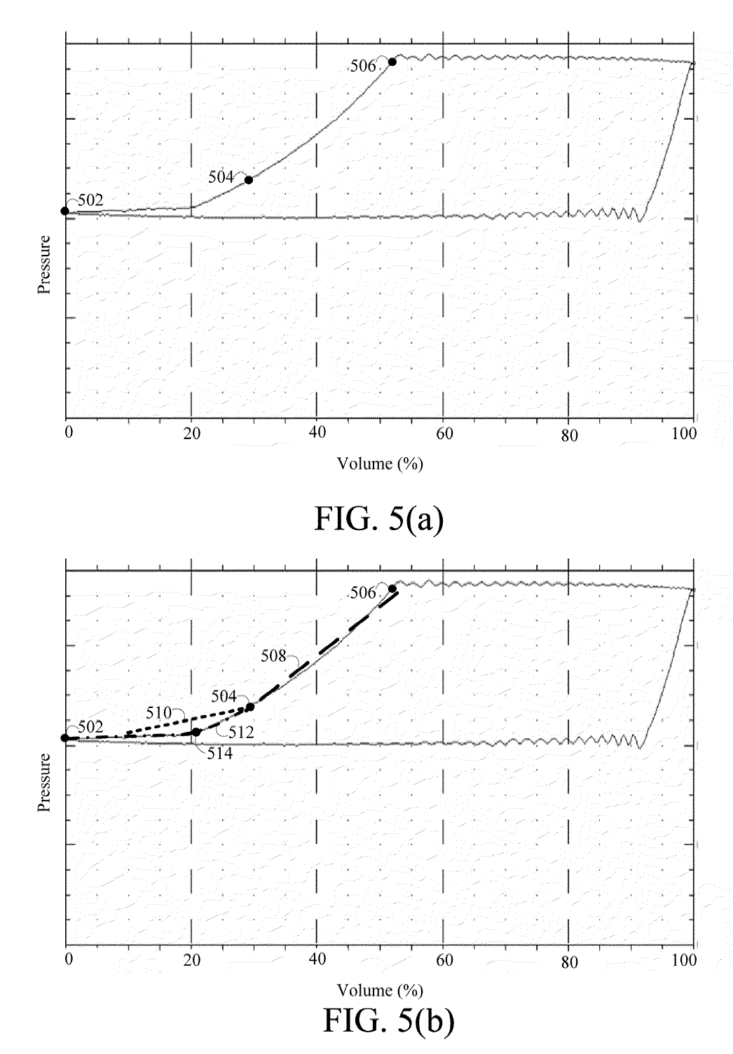

For example, FIG. 5a is a plot of a set of data points. The x-axis represents the volume of the cylinder, and the y-axis represents the pressure within the cylinder. The data points collectively approximate a pressure curve for the compressor, with each data point representing a volume indicator and a pressure indicator. It should be noted that the plot in FIG. 5a appears “flipped over” or reversed in comparison to the plot in FIG. 3, because FIG. 5a pertains to a crank-end chamber while FIG. 3 pertains to a head-end chamber.

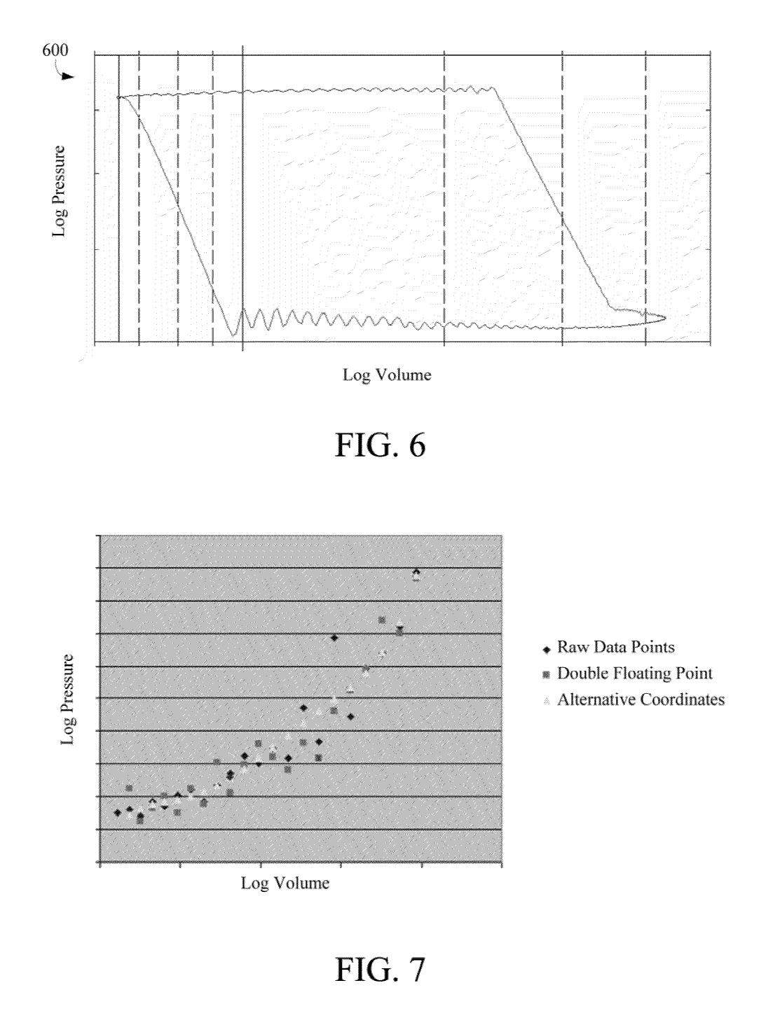

In embodiments, the data points may directly match the samples, meaning the reference and pressure indicators for a given data point may match the reference and pressure readings for the corresponding sample. In other embodiments, the data points may correlate to the samples. For example, the data points may be logarithmic representations of the samples. Each data point may have reference and pressure indicators that are logarithms of the corresponding reference and pressure readings taken from the compressor. Approximating the pressure curve on a logarithmic scale may linearize the data, so that the knee becomes more clearly defined. Thus, the suction valve closure event may be detected with greater accuracy. For example, FIG. 6 is a graph 600 illustrating pressure as a function of compressor volume on a logarithmic scale. The graph 600 is linearized in comparison to the graph 300, which illustrates pressure as a function of compressor volume on a standard scale. Thus, the knee in the graph 600 is comparatively more pronounced than the knee in the graph 300.

In still other embodiments, the sample data may be further processed to reduce noise. Each data point may have a reference indicator that directly correlates to the reference reading for the sample, while the pressure indicator may be a rolling average of pressure readings collected from the compressor in the neighborhood of the sample. For example, the pressure indicator for any given data point may be seven sample rolling average of pressure readings collected from the compressor. The seven sample rolling average may be the average of the pressure readings for the sample, the three previous samples, and the three subsequent samples. Other rolling averages using a larger or smaller number of samples may be employed. Replacing the raw pressure readings with the rolling average may act as a low-pass filter, suppressing high-frequency noise and vibrations. Thus, the accuracy of the method 400 may be improved. For example, a best-fit polynomial equation determined below in block 410 or 414 may more accurately reflect the operation of the compressor, improving the estimate of the detected suction valve closure event.

Returning to block 404, three specific data points may be identified. A suction data point may be defined as the data point associated with a crankshaft rotation angle of 0° (or 180° in the case of a head-end cylinder). An example suction data point 502 is plotted in FIG. 5a. The suction valve closure event is known to occur sometime after the crankshaft rotates past 0° (for a crank-end cylinder), and therefore the suction valve closure event occurs at some point on the pressure curve after the suction data point.

A discharge data point may be defined as the data point at which the discharge valve is estimated to close. An example discharge data point 506 is plotted in FIG. 5a. The suction valve closure event is known to occur at some point before the discharge valve closes, and therefore the suction valve closure event occurs at some point on the pressure curve before the discharge data point. In embodiments, the discharge data point may be defined by starting with the suction data point, iterating through each subsequent data point, and comparing the pressure indicator for the data point to the pressure reading taken at a crankshaft rotation angle of 180° (or 360° for a head-end cylinder). The first data point found to have a pressure indicator that equals or exceeds the pressure reading taken at the crankshaft rotation angle of 180° is defined as being the discharge data point. However, other methods of estimating the discharge data point may be employed.

An index data point is defined between the suction and discharge data points. An example index data point 504 is shown in FIG. 5a. The index data point lies along a relatively linear portion of the pressure curve. The suction valve closure event is known to occur at some point before the pressure in the cylinder linearly increases, and therefore the suction valve closure event occurs at some point on the pressure curve before the index data point. In embodiments, the index data point may be defined by determining a pressure difference between the pressure indicators associated with the discharge and suction pressure points, multiplying the pressure difference by a predetermined factor such as 0.25, and adding the resultant value to the pressure indicator associated with the suction pressure point. In other words, the index data point may be the data point having a pressure increase over the suction data point that is about 25% of the difference between the pressure readings associated with the suction and discharge pressure points. However, other methods of selecting the index data point may be employed.

In block 406, a best-fit linear equation is determined for a first subset of data points, which may include the index data point, the discharge data point, and points collected between the two. An example best-fit linear equation 508 is plotted in FIG. 5b. The best-fit linear equation may take the form of y(x)=Ax+B, where x represents the reference, y represents pressure, A is the slope, and B is the y-intercept. For each data point, (x, y) in the equation may correspond to its (reference indicator, pressure indicator). Together, the data points may be used to identify the slope A and y-intercept B for a best-fit line representing the first subset of data points. For example, the best fit-linear equation 508 plotted in FIG. 5b represents pressure y as a function of volume x, based on data points from about the index data point 504 to about the discharge data point 506. The best-fit linear equation may also be determined in other manners. For example a higher-order best-fit equation may be determined, and a line tangent to the higher-order best-fit equation may be identified. The tangent line may be employed as the “best-fit linear equation” in subsequent blocks of the method 400.

In block 408, the best-fit linear equation is used to determine a half-slope linear equation. The half-slope linear equation has a slope that is about one-half of a slope of the best-fit linear equation, and the half-slope linear equation intersects the best-fit linear equation at about the index data point. In other words, the index data point may be a solution to both the best-fit linear equation and the half-slope linear equation, and the slope of the best-fit linear equation may be about twice the slope of the half-slope linear equation. The half-slope linear equation may take the form of y(x)=(0.5*A)x+C, where A is the slope of the best-fit linear equation. The value of C may be determined upon substituting the (reference indicator, pressure indicator) for the index data point into the half-slope linear equation as (x, y) values, and thereafter solving for C. An example half-slope linear equation 510 is plotted in FIG. 5b.

In block 410, a best-fit polynomial equation is determined for a second subset of data points from about the suction data point to about the index data point. For example, the best-fit polynomial equation may be a sixth-order best-fit polynomial equation having the form y(x)=Dx⁶+Ex⁵+Fx⁴+Gx³+Hx²+Ix+J. Modeling the data with a polynomial such as a sixth-order polynomial may filter the data. Again, x represents the reference parameter and y represents pressure. An example best-fit polynomial equation 512 is plotted in FIG. 5b.

Determining the best-fit polynomial equation may entail identifying the coefficients of the polynomial. For example, six coefficients D, E, F, G, H, I, and J may be determined for the sixth-order best-fit polynomial described above. The coefficients may be identified by performing a numerical analysis technique on the second subset of data points. In embodiments, a least-squares technique may be used to analyze the various data points. Existing programs such as MATLAB® made by The MathWorks, Inc., of Natick, Mass. may be employed to complete the computations. However, such numerical analysis techniques may be computational expensive for the computer. Another program that fits a polynomial to the data points using a least-squares technique, but may require less memory and other system resources, is the routine (svdfit) from Numerical Recipes in C++ by Numerical Recipes Software of Cambridge, Mass.

When the best-fit polynomial equation is determined using conventional double-precision floating point arithmetic, which is the usual industry practice for engineering calculations, the coefficients may be susceptible to loss of precision and round-off error. For example, the best-fit polynomial equation for data points represented on a logarithmic scale may have terms with relatively large magnitudes on a scale of 10¹¹. Some of these terms may be positive, some may be negative, and together the terms may sum to a number having a relatively small magnitude, on a scale of 10⁰ or 10¹. Loss of precision or noise may result. For example, FIG. 7 is a graph illustrating raw data points collected from a compressor, along with a best-fit polynomial computed using double-precision floating point arithmetic. As shown, the best-fit polynomial computed using double-precision floating point arithmetic has an erratic shape that differs from the expected shape for a sixth-order polynomial.

In embodiments, the accuracy of the best-fit polynomial may be improved by computing the coefficients using higher-precision floating-point arithmetic. For example, a computer having a specialized software library configured for implementing higher-precision floating-point arithmetic may be used to determine the coefficients.

In other embodiments, the accuracy of the best-fit polynomial may be improved by determining the best-fit polynomial equation according to an alternative coordinate system. Specifically, the data points may be processed to determine an arithmetic mean reference indicator xₒ from among the set of reference indicators for the data points. The arithmetic mean reference indicator xₒ may be used to convert the best-fit polynomial equation from the coordinate system (x, y) to an alternative coordinate system (x′, y′), where x′=(x−x₀) and y′=y. For example, the sixth-order best-fit polynomial equation described above may be re-written according to the alternative coordinate system as y(x)=D(x−x₀)⁶+E(x−x₀)⁵+F(x−x₀)⁴+G(x−x₀)³+H(x−x₀)²+I(x−x₀)+J. The coefficients and terms of the best-fit polynomial equation are relatively smaller in the alternative coordinate system, and thus the coefficients may be evaluated with improved accuracy and reduced round-off error. FIG. 7 shows an example best-fit polynomial equation computed using the alternative coordinate system. As shown, the data is relatively smooth, closely following the raw data, and showing no detectable scatter. Thus, conventional double-precision floating point arithmetic may be used to perform the calculations on a conventional computer, instead of using higher-precision floating point arithmetic on a specialized computer suited that may be costly to obtain and slow to execute.

In block 412, an initial estimate of the suction valve closure event is obtained by identifying a target reference indicator, somewhere between the suction data point and the index data point, where a directed distance from the best-fit polynomial equation to the half-slope linear equation is a maximum. The term “directed distance” implies a distance from the best-fit polynomial line to the half-slope linear line along a line normal to the half-slope linear equation. The directed distance may be calculated for each reference indicator on the best-fit polynomial line between the suction data point and the index data point. The directed distances may be compared, and a target reference indicator associated with the maximum directed distance may be identified. The suction valve closure event is estimated to occur at the point in the cycle identified by the target reference indicator.

Stated alternatively, a line that is normal to the half-slope linear line may be determined for each reference indicator on the best-fit polynomial line. This normal line may intersect the best-fit polynomial line and the half-slope linear line at two intersection points. The term “directed distance” connotes the magnitude or the length of the normal line between the two intersection points. More specifically, the best-fit polynomial equation, the half-slope linear equation, and the normal line together define a simultaneous set of equations, wherein each of the equations represents pressure (y) as a function of the reference (x). For a given reference indicator (x) on the best-fit polynomial line, the simultaneous set of equations may be solved to determine a magnitude or length of the normal line between the two intersection points, which is the directed distance. The target reference indicator (x), which is associated with the estimated suction valve closure event, is identified by having a maximum directed distance.

An initial estimate of the suction valve closure event is identified as point 514 on FIG. 5b, where the directed distance is at a maximum. It should be noted that the initial estimate of the suction valve closure event may be between data points collected from the compressor. In other words, the suction valve closure event may be estimated with greater resolution than the collected data, as the suction valve closure event is estimated based on continuous equations, while the data points are collected at set intervals, such as every 0.5° of crankshaft rotation. It also should be noted that the initial estimate is a point 514 located on the best-fit polynomial equation that identifies a pressure and a volume. The suction valve is estimated to have closed at the pressure and volume identified by the point 514. Thus, the pressure estimate for the suction valve closure event is the solution to best-fit polynomial equation for the target reference indicator, not the solution to the half-slope linear equation.

In embodiments in which the coefficients of the best-fit polynomial equation are determined using an alternative coordinate system, as described above with reference to block 410, the steps of block 412 may also be completed in the alternative coordinate system, and the final results may be converted back to the original coordinate system. The terms of the polynomial equation may be relatively smaller in the alternative coordinate system, and therefore the equation can be determined with greater accuracy.

In embodiments, the initial estimate of the suction valve closure event may be further refined by taking a second pass through the data. In block 414, a second-best fit polynomial equation may be determined for a third subset of data points. The third subset of data points may be centered about the initial estimate of the suction valve closure event and may include relatively fewer data points than the second subset of data points. For example, the third subset of data points may include a predetermined number of data points on either side of the initial estimate, such as ten data points on either side. The second best-fit polynomial equation may better model the pressure curve in the neighborhood of the suction valve closure event, as remote data points are not considered in obtaining the equation. The second best-fit polynomial equation may be determined as described above with reference to block 410, although for a different subset of data points. Thus, the second best-fit polynomial equation may be a sixth-order best-fit polynomial equation having the form y(x)=Kx⁶+Lx⁵+MX⁴+Nx³+Px²+Qx+R, and determining the equation may entail calculating the coefficients in one of the manners described above. It is noted that the coefficients of the second best-fit polynomial equation differ from the coefficients of the first best-fit polynomial equation, because the second best-fit polynomial equation represents a smaller, and therefore different, subset of data points.

In block 416, an refined estimate of the suction valve closure event is obtained by identifying another target reference indicator, along a range of reference indicators defined by the third subset of data points, having a maximum directed distance from the second best-fit polynomial equation to the half-slope linear equation. The refined estimate may be obtained as described above with reference to block 412. However, the maximum directed distance is determined and compared for a relatively smaller range of reference indicators. Specifically, the target reference indicator may lie somewhere between the suction data point and the index data point, while in block 416 the additional target reference indicator lies on a range defined by the relatively smaller, third subset of data points. It should be noted that, in embodiments, block 414 and 416 may be completed in an alternative coordinate system, as described above with reference to blocks 410 and 412.

In embodiments, the detected suction valve closure event may be compared to an expected suction valve closure point to identify a malfunction in the compressor. For example, a malfunction in the valve, the stepless unloader, or corresponding control equipment may be detected. The suction valve closure event also may be employed in diagnostic or performance calculations for the compressor. The method 400 then ends.

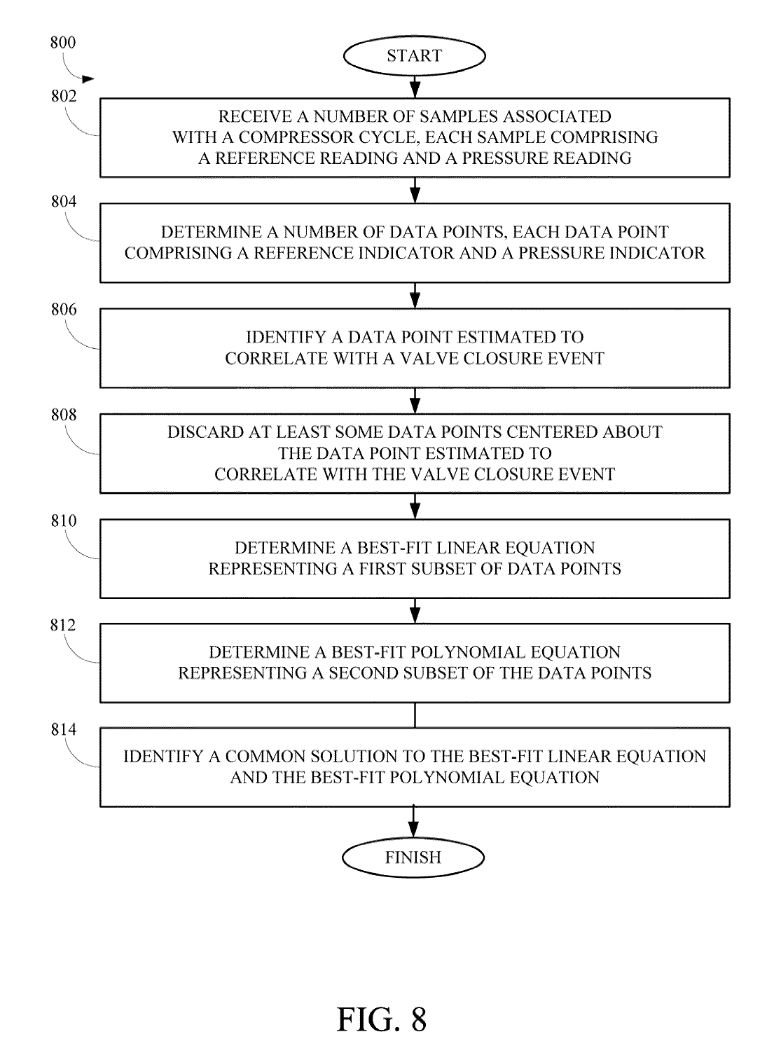

FIG. 8 is a block diagram illustrating another embodiment of a method 800 of detecting closure of a valve in a reciprocating compressor. In block 802, a number of samples associated with at least a portion of the compressor cycle are collected, as described above with reference to block 402 of the method 400. In block 804, the samples may be processed to create a number of data points, as described above with reference to block 404 of the method 400.

In block 806, a data point estimated to correlate with a suction valve closure event is identified. The estimated data point may be identified by performing blocks 406 to 416 of the method 400, as described above. A simplified approach may also be used by performing blocks 406 to 412 of the method 400, as described above. Another simplified approach may substitute the fitting of the best-fit polynomial in block 410 with a rolling average of the data points.

In block 808, at least some data points are discarded. The discarded data points may include the data point estimated to correlate with the suction valve closure event, as identified in block 806. The discarded data points may also include a small number of data points on either side of the data point identified in block 806, meaning a small number of data points that correspond to samples collected immediately before and after the estimated suction valve closure event. In embodiments, the discarded data points may be centered about the data point estimated to correlate with the suction valve closure event.

In block 810, a best-fit linear equation is determined for a first subset of the data points. The first subset of data points may include some or all data points located after the discarded data points. In other words, the first subset of data points may correspond to samples collected after the discarded samples. The best-fit linear equation may be determined as described above with reference to block 406 of the method 400.

In block 812, a best-fit polynomial equation is determined for a second subset of data points. The second subset of data points may include some or all data points located before the discarded data points. In other words, the second subset of data points may correspond to samples collected before the discarded samples. The best-fit polynomial equation may be a parabolic equation having the form x(y)=Sy²+Ty¹+U. The coefficients S, T, and U may be selected to best represent the second subset of data points, the (reference indicator, pressure indicator) of each data point corresponding to (x, y) values in the equation. Thus, the best-fit parabolic equation may correspond to a parabola tipped on its side relative to a conventional parabola of the form y(x)=Vx²+Wx¹+X.

In block 814, a common solution to the best-fit linear equation and the best-fit polynomial equation is identified. The common solution is estimated to indicate the suction valve closure event. The method 800 then ends.

Described above are block diagrams and flowchart illustrations of systems, methods, apparatuses and computer program products according to various embodiments. Each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions. The systems and methods described above may be implemented by computer software and/or hardware.

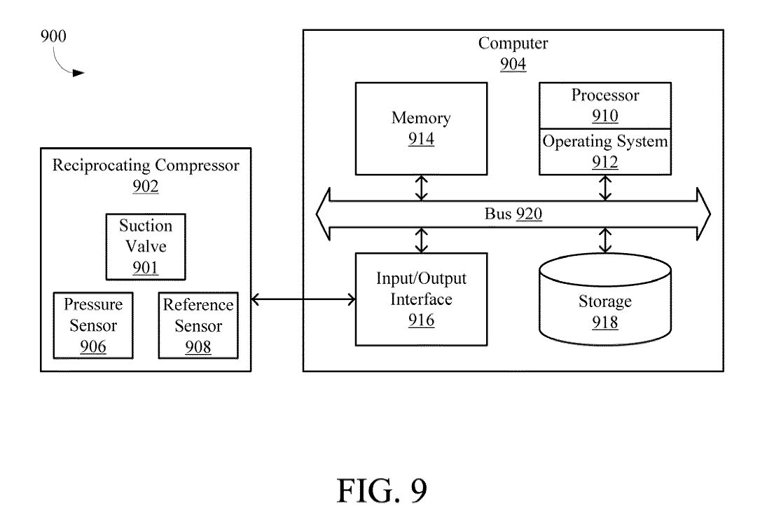

For example, FIG. 9 is a block diagram of a system 900 for detecting closure of a valve 901 in a reciprocating compressor 902. The system 900 may generally include the reciprocating compressor 902 and a computer 904. The reciprocating compressor 902 may include the valve 901, a pressure sensor 906 and a reference sensor 908. The valve 901 may be, for example, a suction valve or a discharge valve. The sensors 906, 908 may be any suitable sensors configured to collect pressure and reference readings from the compressor 902. The compressor 902 and computer 904 may communicate with each other, so that the readings collected from the sensors 906, 908 may be received by the computer 904, such as for purposes described above with reference to block 402 of FIG. 4. The computer 904 may implement a method of estimating closure of the valve 901, such as the method 400 described above with reference to FIG. 4 or the method 800 described above with reference to FIG. 8. Once the closure point of the valve 901 is estimated, the computer 904 may compare the detected closure point of the valve 901 to an expected closure point for the valve 901 to identify a malfunction in the compressor 902, such as a malfunction in the valve 901, a stepless unloader that controls the opening and closing of the valve 901, or control equipment that operates the stepless unloader. The computer 904 may also employ the detected closure point of the valve 901 in diagnostic or performance calculations for the compressor 902.

The computer 904 generally includes a processor 910, an operating system 912, a memory 914, an input/output (I/O) interface 916, a storage 918, and bus 920. The bus 920 may include data and address bus lines to facilitate communication between the processor 910, operating system 912, and other components within the computer 900, including the memory 914, the input/output (I/O) interface 916, and the storage 918. The processor 910 executes the operating system 912, and together the processor 910 and operating system 912 are operable to execute functions implemented by the computer 904, including software applications stored in the memory 914, as is well known in the art. To implement the systems and methods described herein, the processor 910 and operating system 912 are operable with the I/O interface 916 to receive the relevant pressure and reference readings from a reciprocating compressor 910, such as from the sensors 906, 908. In embodiments, the memory 914 may include one or more algorithms for executing the methods described above.

The memory 914 may include random access memory, read-only memory, a hard disk drive, a floppy disk drive, a CD-ROM drive, or an optical disk drive, for storing information on various computer-readable media, such as a hard disk, a removable magnetic disk, or a CD-ROM disk. Generally, the memory 914 receives information input or received by the computer 904, including pressure and reference values from the compressor through I/O interface 916. Using information it receives, the memory 914 effects the methods described in detail above to determine a valve closure event. Therefore, the memory 914 may be operable to execute computations of parameters, compare the parameters against criteria, process information, and the like, as needed to execute the methods described herein.

The storage 918 of the computer 904, which is connected to the bus 920 by an appropriate interface, may include random access memory, read-only memory, a hard disk drive, a floppy disk drive, a CD-ROM drive, or an optical disk drive, for storing information on various computer-readable media, such as a hard disk, a removable magnetic disk, or a CD-ROM disk. In general, the purpose of the storage 918 is to provide non-volatile storage to the computer 904. The storage may include one or more criteria against which the calculated parameters may be compared.

The computer-readable media described above with respect to the memory 914 and storage 918 could be replaced by any other type of computer-readable media known in the art. Such media include, for example, magnetic cassettes, flash memory cards, digital video disks, and Bernoulli cartridges. One or more components of the computer 904 may be located geographically remotely from other components of the computer 904.

It should also be appreciated that the components illustrated in FIG. 9 support combinations of means for performing the specified functions described herein. As noted above, it will also be understood that each of the methods described above, including the processes and computations described with reference to FIGS. 4 and 8, can be implemented by special purpose hardware-based computer systems that perform the specified functions or steps, or combinations of special purpose hardware and computer instructions. Further, the computer 904 may be embodied as a data processing system or a computer program product on a computer-readable storage medium having computer-readable program code means embodied in the storage medium. Any suitable computer-readable storage medium may be utilized including hard disks, CD-ROMs, DVDs, optical storage devices, or magnetic storage devices. Additionally, although illustrated individually in FIG. 9, each component of the computer 904 may be combined with other components within the computer 904 to effect the functions described herein. Accordingly, the computer 904 may take the form of an entirely hardware embodiment, an entirely software embodiment or an embodiment combining software and hardware aspects, such as firmware.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of estimating closure of a suction valve in a reciprocating compressor, the method comprising:
receiving a plurality of samples associated with an operating cycle of the reciprocating compressor, each sample comprising a reference reading and a pressure reading;
determining a plurality of data points, each data point corresponding to one of the samples, each data point comprising a reference indicator and a pressure indicator, the reference indicator directly correlating to the reference reading of the corresponding sample and the pressure indicator correlating to an average of pressure readings collected about the corresponding sample, the plurality of data points comprising:
a suction data point that estimates a beginning of a piston stroke,
a discharge data point that estimates an ending of a piston stroke, and
an index data point corresponding to an interim point on the piston stroke;
determining a best-fit linear equation representing data points from about the index data point to about the discharge data point;
determining a half-slope linear equation, the half-slope linear equation having a slope that is about one-half of a slope of the best-fit linear equation, the index data point being one solution to the half-slope linear equation;
determining a best-fit polynomial equation representing data points from about the suction data point to about the index data point;
identifying a target reference indicator associated with a maximum directed distance from the best-fit polynomial equation to the half-slope linear equation; and
estimating that the suction valve closed at a point in the cycle identified by the target reference indicator.

2. The method of claim 1, wherein the reference reading indicates one or more of the following: a crankshaft rotation angle, volume, time, piston position, a proxy for one of these parameters, or a combination thereof.

3. The method of claim 1, wherein determining a plurality of data points further comprises representing the samples on a logarithmic scale.

4. The method of claim 1, wherein the pressure indicator for each data point correlates to a seven sample rolling average of pressure readings collected about the sample corresponding to the data point.

5. The method of claim 1, wherein determining a best-fit polynomial equation comprises determining a best-fit sixth-order polynomial equation.

6. The method of claim 1, further comprising refining the estimate of the suction valve closure point by:
determining a second best-fit polynomial equation representing a subset of data points centered about the target reference indicator;
identifying a second target reference indicator associated with a maximum directed distance from the second best-fit polynomial equation to the half-slope linear equation; and
estimating that the suction valve closed at a point in the cycle identified by the second target reference indicator.

7. The method of claim 1, wherein determining a best-fit polynomial equation comprises determining a best-fit polynomial equation in an alternative coordinate system, the method further comprising:
converting the data points to the alternative coordinate system by reducing the pressure indicator for each data point by an arithmetic mean of the pressure indicators of substantially all of the data points.

8. The method of claim 7, further comprising converting the target reference indicator from the alternative coordinate system by adding the arithmetic mean to a pressure indicator that corresponds to the target reference indicator.

9. The method of claim 1, further comprising:
comparing the estimated suction valve closure point identified by the target reference indicator with an expected suction valve closure point to detect a malfunction in one or more of the following: the suction valve and a stepless unloader.

10. The method of claim 1, further comprising:
employing the estimated suction valve closure point identified by the target reference indicator in diagnostic or performance calculations for the compressor.

11. A compressor system comprising:
a compressor comprising a suction valve; and
a computer operative to:
receive a plurality of samples associated with an operating cycle of the reciprocating compressor, each sample comprising a reference reading and a pressure reading;
determine a plurality of data points, each data point corresponding to one of the samples, each data point comprising a reference indicator and a pressure indicator, the reference indicator directly correlating to the reference reading of the corresponding sample and the pressure indicator correlating to an average of pressure readings collected about the corresponding sample, the plurality of data points comprising a suction data point that estimates a beginning of a piston stroke, a discharge data point that estimates an ending of a piston stroke, and an index data point corresponding to an interim point on the piston stroke;
determine a best-fit linear equation representing data points from about the index data point to about the discharge data point;
determine a half-slope linear equation, the half-slope linear equation having a slope that is about one-half of a slope of the best-fit linear equation, the index data point being one solution to the half-slope linear equation;
determine a best-fit polynomial equation representing data points from about the suction data point to about the index data point;
identify a target reference indicator associated with a maximum directed distance from the best-fit polynomial equation to the half-slope linear equation; and
estimate that the suction valve closed at a point in the cycle identified by the target reference indicator.

12. The compressor system of claim 11, wherein the compressor further comprises:
a pressure sensor operative to obtain the pressure readings from the compressor; and
a reference sensor operative to obtain the reference readings from the compressor, wherein the reference readings indicate one or more of the following: a crankshaft rotation angle, volume, time, piston position, a proxy for one of these parameters, or a combination thereof.

13. The compressor system of claim 11, wherein:
the compressor further comprises a crank-end cylinder and a crankshaft;
the operating cycle comprises at least a suction cycle and a compression cycle; and
the plurality of samples are collected as the crankshaft rotates at least between bottom dead center and top dead center.

14. The compressor system of claim 11, wherein:
the compressor further comprises a head-end cylinder and a crankshaft;
the operating cycle comprises at least a suction cycle and a compression cycle; and
the plurality of samples are collected as the crankshaft rotates at least between top dead center and bottom dead center.

15. The compressor system of claim 11, wherein the computer is further operative to refining the estimate of the suction valve closure point by:
determining a second best-fit polynomial equation representing a subset of data points centered about the target reference indicator;
identifying a second target reference indicator associated with a maximum directed distance from the second best-fit polynomial equation to the half-slope linear equation; and
estimating that the suction valve closed at a point in the cycle identified by the second target reference indicator.

16. The compressor system of claim 11, wherein:
the compressor further comprises a stepless unloader; and
the computer is further operative to detect a malfunction in one or more of the suction valve and the stepless unloader by one or more of the following:
comparing the estimated suction valve closure point identified by the target reference indicator with an expected suction valve closure point; and
employing the estimated suction valve closure point identified by the target reference indicator in diagnostic or performance calculations for the compressor.

17. A method of estimating closure of a suction valve in a reciprocating compressor, comprising:
receiving a number of samples associated with a compressor cycle, each sample comprising a reference reading and a pressure reading;
determining a number of data points, each data point comprising a reference indicator and a pressure indicator, each data point corresponding to one of the samples, the reference and pressure indicators for the data point correlating with the reference and pressure readings of the corresponding sample;
identifying a data point correlating with an estimated suction valve closure event;
determining a best-fit linear equation representing a first subset of data points, the first subset of data points corresponding to samples collected after the estimated suction valve closure event;
determining a best-fit polynomial equation representing a second subset of data points, the second subset of data points corresponding to samples collected before the estimated suction valve closure event;
identifying a common solution to the best-fit polynomial equation and the best-fit linear equation; and
identifying a refined estimated suction valve event, the common solution indicating reference and pressure indicators that identify the refined estimated suction valve closure event.

18. The method of claim 17, wherein the reference reading indicates one or more of the following: a crankshaft rotation angle, volume, time, piston position, a proxy for one of these parameters, or a combination thereof.

19. The method of claim 17, further comprising discarding a plurality of data points substantially centered about the data point correlating with the estimated suction valve closure event, the discarded data points corresponding to discarded samples, wherein the first subset of data points corresponds to samples collected after the discarded samples, and the second subset of data points corresponding to samples collected before the discarded samples.

20. The method of claim 17, wherein determining a best-fit polynomial equation comprises determining a best-fit second order polynomial equation.
